(19) United States
(12) Patent Application Publication
(10) Pub. No.: US 2012/0094875 A1
(43) Pub. Date: Apr. 19, 2012

(54) PRODUCTION PROCESS OF HIGH AFFINITY AND HIGH SPECIFICITY OLIGONUCLEOTIDES FOR ORGANIC AND INORGANIC MOLECULES

(76) Inventor: Luiz Augusto Pinto, Belo Horizonte (BR)

(21) Appl. No.: 13/255,672

(22) PCT Filed: Mar. 12, 2010
(86) PCT No.: PCT/BR10/00076

§ 371 Date: Sep. 9, 2011

(30) Foreign Application Priority Data
Dec. 3, 2009 (BR) P10901112-9

(51) Int. Cl. C40B 50/06; B01D 43/00; C40B 50/00

(52) U.S. Cl. 506/26; 506/23; 204/451

(57) ABSTRACT

The object of this patent advances the State of the Art by the following innovations:

1^{st}—It creates a new electrophoretic process to be carried out in fused silica capillary that was previously covered internally with neutral hydrophilic substances that reduces the seven mandatory steps of the electrophoretic process according to the State of the Art into one single electrophoretic migration in the new process, with high power of separating the “protein oligonucleotide” compound, which allows the achievement of results in which the sample protein, as well as other substances, get physically well separated from similar complexes, therefore attaining a narrow compound zone in the internally covered capillary tube, constituted of the sample protein bound to, at least, one oligonucleotide by means of the stronger and specific bound, eliminating the fraction collection window which is a typical phenomenon described in the State of the Art.
2^{nd}—Development of a fused silica capillary internally covered with neutral hydrophilic substances that nullify the polarizing effects of the fused silica internal surfaces of the conventional capillaries, which eliminates the electroosmotic flux, which serves as basis for the creation of the new process described above, being such substances the octadecylsilyls, polyvynilsiloxanes, cyclodextrins, cellulose, polymetacrilate, amino acids, proteins, peptides, polyamines, other organic acids or any other ones that produce the same phenomenon, for having the same or similar properties.

### FIELDS OF THIS PATENT

Capillary electrophoresis.
Isolation process of proteins and other substances bound to oligonucleotides in one single stage by means of a capillary electrophoresis through a capillary tube internally covered by neutral hydrophilic substances.
Accuracy, speed and economy in isolating proteins and other substances linked to oligonucleotides.
Elimination of the electroosmotic effect on capillary electrophoresis.
Internal covering of capillaries by neutral hydrophilic substances.
Development of high affinity and high specificity oligonucleotides, the aptamers, for proteins or other nonproteic molecules.

### STATE OF THE ART

The worldwide scientific community uses the State of the Art of the “Electrophoretic Separation in Capillary” by observing action methods which facilitate the comparisons of the results found by several researchers; thus, the length of the capillary tubes, the tension applied to their ends, the pKa of the buffer solutions, as well as their own constitutions and the temperatures in which the operations take place, that is, the experiment “conduction protocols” keep the principle that, “under the same conditions, the same causes produce the same effects”, which is methodologically extended to “under the same conditions, different causes must have different causes”, in such case, under the same conditions, the specific electrophoretic migratory behavior of one substance inside a capillary tube is due to its specificity and differs from the behavior of all other substances.

Thus, from studies that safely indicate that an unknown protein, stemmed from a certain source, which is linked to one or more than one oligonucleotide present in the library of oligonucleotides after a particular time of electrophoretic migration in a capillary under standardized conditions and apparatus, has such behavior, the scientific community is able to start the research being sure that it refers to the same object of research.

The use of the library of oligonucleotides for obtaining high affinity and high specificity oligonucleotides for a sample protein was established in two scientific studies published in the year of 1990:

1^{st}—Tuerk & Gold, “Systematic evolution of ligands by exponential enrichment: RNA ligands to bacteriophage T4 DNA polymerase”, Science 1990; 249:505-10;
2^{nd}—Ellington & Szostak, “In vitro selection of RNA molecules that bind specific ligands”, Nature 1990; 346:818-22.

The attained oligonucleotides were named “aptamers” by the worldwide scientific community.

Once firmed up and confirmed experimentally, the particular behavior of a sample of a certain protein bound to one or more than one oligonucleotides (aptamer) in electrophoretic migrations in a capillary, the event of an identical behavior in a protein sample indicates the presence of this specific protein; it is its “fingerprinting”.

Consequently, the oligonucleotide bound to such protein, the aptamer, acts as a specific antibody for it as it was bound to it throughout the electrophoretic migration and it can be separated from it and reproduced in large industrial scales by several known methods, such as the Polymerase Chain Reaction (PCR) and the cloning in bacteria through cloning vectors. Thus, through the technique described below, one can identify and isolate oligonucleotides which can act as aptamers, highly specific antibodies for certain proteins making strong chemical links with them in order to reveal their presence when in contact with such oligonucleotides.

The State of the Art of Non-Equilibrium Capillary Electrophoresis Of Equilibrium Mixtures (NECEEM)—Based Methods For Drug And Diagnostic Development”, described and patented under the number U.S. Pat. No. 7,672,786 B2, is a patent granted on Mar. 2, 2010, which is the following:
According to the State of the Art, the attainment of the compound formed by the protein sample strongly bound to its specific oligonucleotide, its aptamer, in a high purity degree, is obtained through the following eight steps, of which the seven first ones are mandatory and the eighth one is optional, in case of wishing to amplify the aptamer obtained in high purity degree:
   1^{st} step—the capillary electrophoretic migration of the proteic sample is carried out and the result—distance crossed and the profile of the fraction due to time—is recorded,
   2^{nd} step—the migration of the library of oligonucleotides sample that is not bound to any protein sample, which contains around 10¹⁴ different oligonucleotides, is carried out and the result—distance crossed and the profile of the fraction due to time—is recorded,

The order of these two first steps may be any and both can be carried out simultaneously under identical conditions and apparatus.

3^{rd} step—the capillary electrophoretic migration of the proteic sample is carried out after it has reacted to the library of oligonucleotides sample and it has been linked to one or more than one oligonucleotides; although the ideal condition to be attained at the end of this third electrophoretic migration is the clear physical separation in a narrow zone along the capillary of a compound formed by at least one oligonucleotide specifically and strongly bound to the sample protein, in practice, by the current State of the Art, this does not take place and the physical separation of such compound along the capillary tube appears as occupying a wide zone of the capillary, called fraction collection window.
4^{th} step—the compounds of the sample protein, formed by its bound to one or more than one oligonucleotides that are located in the fraction collection window area, are isolated and amplified by the PCR (Polymerase Chain Reaction).
5^{th} step—the oligonucleotides obtained by the amplification through the PCR technique, described in the 4^{th} step above, are subjected to the fourth electrophoretic migration under the same previous conditions and in the presence of the sample protein so that a purer compound is attained in the capillary tube region which is called fraction collection window by the current State of the Art.
6^{th} step—the compounds of the sample protein formed by its links with one or more than one oligonucleotides lying in the region of the fraction collection window that were attained at the end of the 5^{th} step are isolated and amplified by the PCR (Polymerase Chain Reaction).
7^{th} step—the oligonucleotides obtained by the amplification through the PCR technique in the 6^{th} step are subjected to the fifth electrophoretic migration, under the same conditions and in the presence of the sample protein in order to obtain a purer compound in a clearer and narrower position inside the capillary tube, peak-like, which has the purpose to isolate the fraction in which the specific bound of the oligonucleotide to the sample protein subjected to the electrophoretic migration is stronger, that is, to obtain the aptamers with a high purity degree.
8^{th} step, optional—the aptamers, identified in the 7^{th} step described above, shown as peaks in the fifth electrophoretic migration, are isolated and subjected to the amplification for their attainment in large industrial scales by means of the several known methods, such as the Polymerase Chain Reaction (PCR) and the cloning in bacteria through the cloning vectors.

As the eight steps of the State of the Art described above are completed, specific high affinity oligonucleotides, the aptamers, are attained for the sample protein.

### STATE OF THE ART REVIEW

Here are the problems due to the current State of the Art:

1—due to the similarities of the electrical polarization values and of the molecular masses of the substances which are involved, there are several bounds of oligonucleotides to the involved sample that are poorer, so that the result is not in the form of a concentration peak of the compound formed by the reaction of the sample protein with one single specific bound oligonucleotide, but the distribution of the results of the electrophoretic migration through a relatively large space in the capillary—fraction collection window—which means that the proteic sample is bound to several oligonucleotides, in several degrees of link force and that these varied compounds are physically located in this region called fraction collection window and not exactly in one single and certain clear peak of the electrophoretic behavior.

In other words, this means that in such electrophoretic migration, it was not possible to separate and place a specific ligand strongly bound to the sample protein—the aptamer—in an exact and differentiated position in one single step, which, when it happens, it is shown in the electropherogram in the form of a peak of abrupt rise and fall.

2—As a result of this separation with a smaller degree of discrimination and little clarity of the physical separation of the fractions of the electrophoretic migration, the accurate isolation of a sample of an unknown protein strongly bound and that is specific to one or more than one oligonucleotides present in the library of oligonucleotides requires the eight, steps described above in order to be accurate, whose consequences are as follows:
A—it is a delayed process,
B—it is a process with a big risk of contamination due to the big number of manipulations,
C—it is an expensive process.
3—These great disadvantages of the State of the Art are due to the phenomena of superficial interaction between the internal surface of fused silica, of which the capillaries are made, with the buffer aqueous solution used for carrying out the electrophoretic migration, which leads to the phenomenon called electroosmotic flux or electroosmosis.

The electroosmotic flux is an inseparable consequence of the electrophoresis carried out in the fused silica capillaries.

The relation “capillary internal surface area/volume of the liquid inside it” is very large—the capillaries have between 10 and 100 micron of internal diameter—and this makes the phenomena of interaction of the fused silica surface of the capillaries with the buffer solution to be significant. On the internal surface of the conventional fused silica capillaries subjected to the action of water and/or buffer solutions with alkaline pH, the Silanol groups get ionized thus forming a negative surface.

Such ionization leads to the formation of:

A—a fixed layer of positive ions overlapping the internal surface of the capillary of the electrophoretic solution compounds in order to keep the electroneutrality,
B—a second layer, which immediately overlaps the first one, is diffuse and also electrically positive.

When the electrical field is applied to the ends of the capillary, electrical forces act on the charges of the so-called diffuse layer and such cations draw water molecules, thus forming a flow that is taken to the cathode while the capillary wall remains negative.

This phenomenon is called electroosmotic flux or electroosmosis.

As the electrostatic field applied to the electrophoresis is of around 15 kV and it is applied from a distance of around 50 cm, this means that an electrical field of about 300 V/cm is strong enough for making the migration of a water current towards the cathode to take place, such current that flows to the opposite direction of the flow of the molecules formed by the fusion of the oligonucleotides and proteins that start to migrate through the electrophoretic migration towards the anode of the apparatus.

The migration of the “protein-oligonucleotide” complex takes place towards the anode due to the big number of negative charges of the phosphate ions present in the oligonucleotides.

Thus, it can be stated that the migration speed of the “protein-oligonucleotide” complex towards the anode is lower than the speed it would go if there were not the electroosmotic flux, that is, the water flow of the “mobile phase” towards the cathode, due to the negative polarization of the fused silica surface of the capillary.

The electroosmotic flux is something chaotic since it is constrained by the narrow diameter of the fused silica capillary and it delays the migration of the “protein-oligonucleotide” complex towards the anode, in such a way that during the time of migration, several of those complexes—formed by the protein bound to different kinds of oligonucleotides—which have very similar molecular charges and masses, they get very little away from each other, forming mixture of a wide spectrum called fraction collection window, that is, an extensive region of similar compounds—and, therefore, they are not pure—which is obtained with the conventional electrophoretic methods, when non-covered fused silica capillaries are used.

### Advances Brought about to the State of the Art by the Object of this Patent

The object of this patent, “SINGLE-STAGE ELECTROPHORETIC PROCESS IN A COVERED CAPILLARY TUBE FOR ACCURATELY SEPARATING THE PROTEIN-BOUND OLIGONUCLEOTIDES”, besides being a valuable advance to the filed patent number PCTBR12010/000076, entitled “PRODUCTION PROCESS OF HIGH AFFINITY AND HIGH SPECIFICITY OLIGONUCLEOTIDES FOR ORGANIC AND INORGANIC MOLECULES”, by the same author, it advances the State of the Art with the four following innovations:

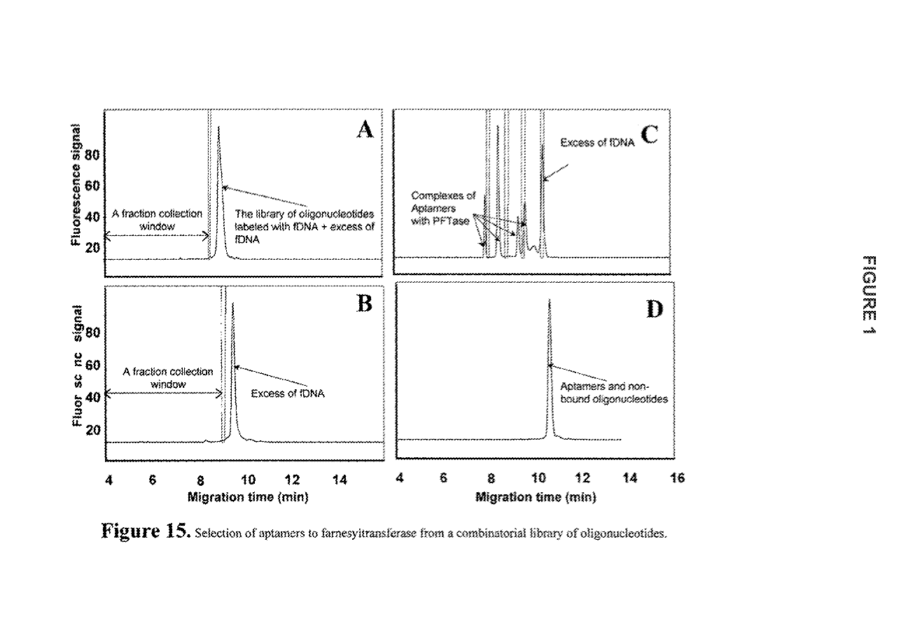

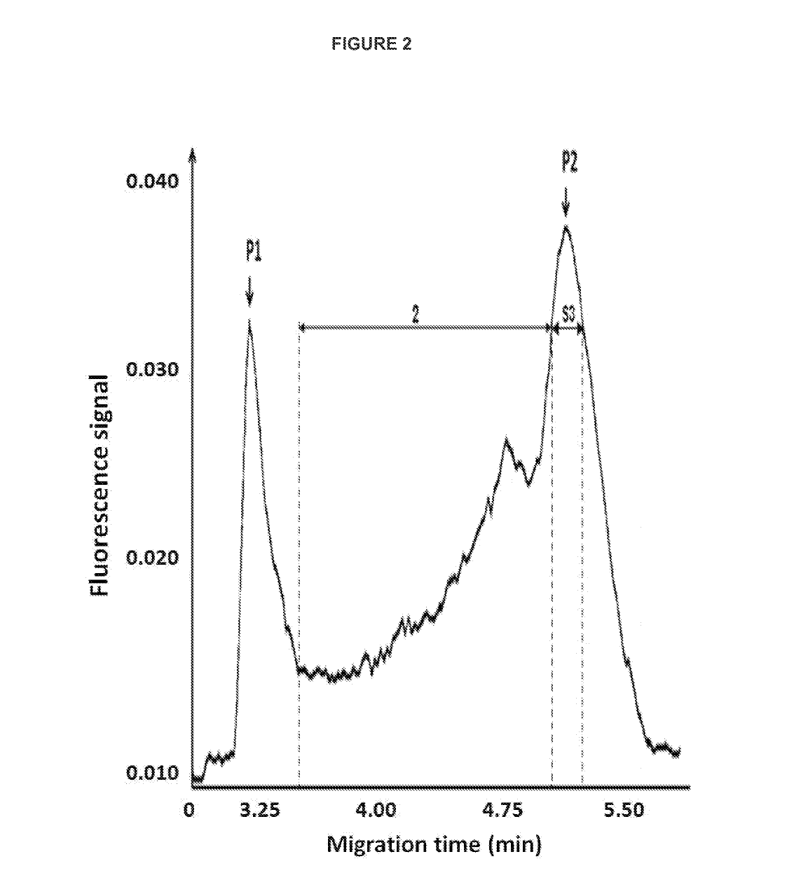

First innovation:—The creation of a new electrophoretic process in a capillary tube that is internally covered with neutral hydrophilic substances, according to the proper description in this Report, process in which a compound formed by the sample protein bound to one or more than one oligonucleotides that have high specificity and high affinity with the proteic sample is collected with a high degree of purity, being that this compound appears in the electropherogram, in the form of a clear peak of separation and localization inside the capillary, reducing six of the mandatory seven steps and one optional step of the current State of the Art process into a single one with only one electrophoretic migration;
Second innovation:—elimination of the fraction collection window by eliminating the electroosmotic effect due to the use of a capillary internally covered by neutral hydrophilic substances and, consequently, elimination of the need of carrying out consecutive electrophoretic migrations and amplifications through the PCR which constitute the first, second, fourth, fifth, sixth and seventh steps described in the Stare of the Art;
Third innovation:—unlike the description of the State of the Art, in which the material of interest of the electrophoretic migration is collected in a large region of the capillary, called fraction collection window, in this new process, only a chosen and central part is collected from the highest point of the electrophoretic separation peak of the compound formed by the sample protein bound to one or more than one oligonucleotides with high specificity and high affinity with the proteic sample, thus being such collection technique an efficient purification technique as it will be properly illustrated by FIG. 2, which is partly responsible for the reduction of the seven mandatory steps of the process described by the State of the Art into one single step. The comparison between FIGS. 1 and 2 shows the advances in the State of the Art brought about by the object of this patent.
Fourth innovation:—development of fused silica capillaries internally covered by neutral hydrophilic substances, as it will be properly described in this Report, in order to eliminate the electroosmotic effect that is typical in the fused silica capillaries to allow the universal-library free oligonucleotides to be separated accurately and with a high purity degree from the oligonucleotides bound to proteins in one single electrophoretic migration.

FIG. 1 shows the typical results obtained in electrophoretic migrations according to the State of the Art;

FIG. 2 shows the typical results obtained in electrophoretic migrations according to the innovations of the object of this patent.

The FIG. 1 of this Report is the exact reproduction of the “FIG. 15, Sheet 15 of 16 of the U.S. Pat. No. 7,672,786 granted on Mar. 2, 2010” and it shows the typical electropherograms of the State of the Art and it corresponds to the results obtained by the 2^{nd}, 3^{rd}, 5^{th} and 7^{th} steps of the seven mandatory steps of the State of the Art, as it was previously cited in this paper.

In this FIG. 1, we can see on the chart (D) the illustration of the 2^{nd} mandatory step of the State of the Art, where the electrophoretic behavior profile of the sample protein-non-bound oligonucleotides of the library of oligonucleotides is observed, such aptamers and non-bound oligonucleotides isolate themselves in the peaks after a course of 10 minutes; we can also see the chart (A) that represents the third mandatory step of the State of the Art, in which the sample protein and the library of oligonucleotides were subjected to the capillary electrophoresis after they were put for reacting, thus generating the typical phenomenon of the State of the Art called fraction collection window, which corresponds to the physical space of the capillary made of fused silica non-covered internally, constrained between the period of 4 minutes and 8 minutes of this specific migration that, according to the State of the Art, corresponds to the region of the capillary in which there is a higher probability of finding the sample protein bound to a set of oligonucleotides of the library of oligonucleotides, with several affinity degrees.

As it can be seen in the chart (A) of FIG. 1, the amount of the compound formed by the sample protein bound to the oligonucleotides of the library of oligonucleotides, obtained by this State of the Art, is diffuse in a wide area of the capillary, forming the fraction collection window, which determines that through this technique, the oligonucleotides collected there must be subjected to the 4^{th} mandatory step of the State of the Art, which is the amplification by the PCR.

In FIG. 1, the chart (B) illustrates the 5^{th} mandatory step of the State of the Art, in which the oligonucleotides amplified by the PCR during the 4^{th} step are placed together with the sample protein in a new migration for a new collection in the fraction collection window, in the period between 4 minutes and 8 minutes.

The collected material is subjected to the 6^{th} step for amplification by the PCR. The product of this amplification is subjected to the 7^{th} mandatory step, described in the State of the Art, which is represented by the chart (C) of the FIG. 1, where high affinity oligonucleotides, aptamers bound to the sample protein, can be identified, appearing as four peaks (Complexes of Aptamers with PFTase). The aptamers identified in the 7^{th} step are isolated and they can be amplified by the 8^{th} step, which is optional, of the State of the Art.

FIG. 2 is a typical electropherograms obtained in an electrophoretic migration of one single step and with a high discrimination power, according to the descriptions of the innovations of the object of this patent; in it, we can see the Peak (P1) that corresponds to the oligonucleotides of the library of oligonucleotides that have not been bound to the sample protein and which, due to the electroosmotic effect elimination caused by the use of fused silica capillary covered internally with neutral hydrophilic substances, object of this patent, migrated during the first 3.25 minutes of the electrophoretic migration; we can also see in the same FIG. 2, the Peak (P2) that corresponds to the sample protein strongly linked to one or more than one oligonucleotides, being that the space (2) between Peak (1) and Peak (2) corresponds to several oligonucleotides with low and medium affinities with the sample protein and they are separated from it between 3.25 and 4.25 minutes and they will be discarded together with the oligonucleotides of the Peak (P1); the material to be collected by the process object of this patent is just the fraction lying inside the segment of the variable extension for collection (S3), located inside the Peak (P2).

This collection of the compound fraction lying inside the Peak (P2) has its level of capacity of purification as a function of the “time-space” dimension of the segment of the variable extension for collection (S3) and it is determined by the analyst according to the level of purification the wants to impose to the process; the bigger the extension of the variable extension segment for collection (S3), the bigger the chance to have more than one high affinity and high specificity oligonucleotides bound to the sample protein; reciprocally, the smaller the extension determined for the variable extension segment for collection (S3), the smaller such probability is. The comparison of the electropherograms in the FIG. 1 and in the FIG. 2 shows that:

1^{st}—the sample protein compound strongly bound to one or more than one oligonucleotides gets isolated inside the covered capillary in one clear concentration peak when the object of this patent is used, unlike the one found in the large fraction collection window, according to the State of the Art; therefore, the object of this patent reduces the seven mandatory steps described in the State of the Art into one single stage for separating the protein-bound oligonucleotides accurately;
2^{nd}—the appearance of an acute concentration peak of the compound formed by the sample protein with the oligonucleotides bound to it in a narrow region inside the covered capillary enables the analyst to collect such compound with a high purity degree.
3^{rd}—the behavior of the substances under analysis during the electrophoretic migration, when they do not suffer the effects of the electroosmotic flux, which get separated right in the beginning of the electrophoretic migration, is contrary to what happens when they are subjected to electrophoretic migrations in non-covered capillaries, according to the State of the Art.
4^{th}—the formation of the fraction collection window during the conventional electrophoretic process takes 240 seconds, according to FIG. 1; and, for obtaining the Peak (2), it takes only 30 seconds, according to FIG. 2, which exemplifies the innovations to the State of the Art object of this patent.
5^{th}—through the State of the Art, the formation of the fraction collection window is necessary for collecting the material in the third and fifth steps and at the end of the migration takes around 900 seconds whereas with the innovations to the State of the Art introduced by the object of this patent, the total electrophoretic migration time is of 360 seconds and the collection period takes until 30 seconds.

The electropherogram of the object of this patent's process, shown in FIG. 2, was carried out according to the procedure described as follows. The Ferritin Protein, obtained from the human blood plasma, was used as sample protein to characterize and exemplify a typical result of the process, object of this patent. During the process, a library constituted of 10¹⁴ oligonucleotides made of single strand DNA bought from IDT Technologies (USA—http://www.idtdna.com); this library is constituted of sequences of DNA marked with fluorescein in the end 5′ (line five) containing two preserved regions (19-mer and 22-mer) and a random region (39-mer), constituted of a same likelihood of occurrence of the four nucleotides A, T, C and G, being the sequence as the following: —5″-FAM-CTT CTG CCC GCC TCC TTC CNN NNN NNN NNN NNN NNN NNN NNN NNN NNN NNN NNN NNN NGG AGA CGA GAT AGG CGG ACA CT-3, where N represents a random nucleotide.

For performing the capillary electrophoretic process, object of this patent exemplified in FIG. 2, a commercial apparatus PACE MDQ model (Beckman-Coulter, EUA) equipped with a fluorescence induction laser at the frequency of 480 nm and a fluorescence detector at 520 nm was used. The internally covered capillaries made of fused silica, object of this patent, used in the electrophoretic process, have their development described below in this Report. For the process exemplified in FIG. 2, the internally covered fused silica capillary has the following specifications: total length of 60 cm; detection point of the laser-induced fluorescence at 45 cm from the initial end of the capillary; internal diameter of 75 μm and external diameter of 375 μm.

FIG. 2 shows the electropherogram of the electrophoretic migration carried out with the library oligonucleotides dissolved in a buffer (Tris-acetate 50 mM with pH 8.2, NaCl 100 mM and MgCl₂ 5 mM) at the final concentration of 100 μm and a final volume of 5 μl, to which a sample of 1 μl of the Ferritin protein dissolved in the concentration of 2.4 mg/ml was added to the same buffer of the library of oligonucleotides. The sample of the Ferritin protein mixed with the library of oligonucleotides was kept in a temperature of 23° C. for 15 minutes in order to be then subjected to the electrophoretic migration, in a way that this sample was injected into the capillary by means of a pressure pulse of 0.5 psi. Before the migration, the capillary was washed for 5 minutes with a buffer solution Tris-acetate 50 mM with pH8.2, which was the same buffer used during the electrophoretic migration carried out in an electrical field of 18 kV (300 V/cm). The electropherogram obtained after 6 minutes of the electrophoretic migration in the internally covered capillary, object of this patent, is shown in FIG. 2.

It must be understood that the invention shown in this Report must not be limited to the example represented by FIG. 2; the invention allows several changes and arrangements that are equivalent to other proteins, other than the Ferritin protein which was used just as an example in this Report.

Likewise, the process described in this Report, object of this patent, can be applied to other nonproteic substances.

The fourth innovation—the fused silica capillaries internal surfaces being covered with neutral hydrophilic molecules, object of this patent—is purposed to nullify the polarizing effects of the fused silica surfaces of the conventional capillaries and to eliminate the electroosmotic flux.

Molecules that have the property of getting bound to the Silanol groups by surface adsortion are applied in the internally covered capillaries with hydrophilic substances after a specific physical-chemical treatment of the internal surface of the fused silica capillaries and, therefore, nullify the electrostatic forces that the ionized silanol groups have on the water molecules, thus eliminating the eletroosmotic flux that occurs during the electrophoretic migrations carried out in conventional fused silica capillaries that are not internally covered.

The neutral hydrophilic molecules used for covering the internal surfaces of the capillaries, object of this patent, can be octadecylsilyls, polyvynilsiloxanes, cyclodextrins, cellulose, polymetacrilate, amino acids, proteins, peptides, polyamines, other organic acids or any other ones that produce the same phenomenon, for having the same or similar properties. The process for covering the internal surfaces of the fused silica capillaries, object of this patent, takes place in three stages:

In the first stage, the following steps are taken:

1^{st} step—filling up the capillary with HCl in the concentration of 12 M, sealing the capillary ends with flame and incubation at 80° C. for 12 hours;
2^{nd} step—washing the interior of the capillary with deionized water followed by its washing with propanone, followed by its washing with dyethyl ether, such process being repeated five times by using the PA reagents.
3^{rd} step—drying the capillary with a Nitrogen flow for one hour in room temperature;
4^{th} step—filling up the capillary with an ammonium hydrogen fluoride solution (NH₄HF₂) at 5% in weight per volume, dissolved in methanol and keeping it at rest for an hour in room temperature;
5^{th} step—drying the capillary with a Nitrogen flow for 30 minutes in room temperature;
6^{th} step—sealing the ends of the capillary with a flame and heating it at temperatures between 300° C. and 400° C. for 3 or 4 hours.

In the second stage, the following steps are carried out:

1^{st} step—treating the capillary internal surface with a continuous flow of ammonia solution of 0.1-0.2 ml/h (6 mM, pH 10), for 20 hours;
2^{nd} step—washing the interior of the capillary with deionized water followed by its washing with HCl (0.1 M) and, finally, with a new washing with deionized water;
3^{rd} step—drying the capillary with a Nitrogen flow for 30 minutes in room temperature;
4^{th} step—filling up the capillary with a trietoxisilane solution (1.0 M) dissolved in dioxane, sealing the capillary with a flame and incubating it for 90 minutes at 90° C.;
5^{th} step—washing the internal surface of the capillary with a continuous flow of 0.1-0.2 ml h of hexachloroplatinic acid (THF) for 2 hours, followed by a new washing with a THF solution dissolved in water (1:1) for 2 more hours;
6^{th} step—drying the capillary with a Nitrogen flow for 30 minutes at room temperature;
7^{th} step—washing the capillary with toluene for 5 minutes;
8^{th} step—treating the internal surface of the capillary with a continuous flow of 0.1-0.2 ml/h of hexachloroplatinic solution 10 mM, dissolved in 2-propanol heated at 100° C. for 90 hours;
9^{th} step—about 10 alternated washes of hexachloroplatinic acid and toluene for 1 hour.

In the third stage, the capillary internal surfaces are bound to the neutral hydrophilic molecules chosen to cover the internal surfaces and it is consisted of the following steps:

1^{st} step—the choice of the substance that will be used for the covering can be:—octadecylsilyls, polyvynilsiloxanes, cyclodextrins, cellulose, polymetacrilate, amino acids, proteins, peptides, polyamines, other organic acids or any other ones that produce the same phenomenon, for having the same or similar properties;
2^{nd} step—treatment of the capillary internal surface with a continuous flow of 0.1-0.2 ml h of a solution of the substance chosen in step 1, heated at 100° C. for 90 hours.

In sum, by using capillaries that are internally covered with hydrophilic substances, as described above in this Report, the object of this patent—“SINGLE-STAGE ELECTROPHORETIC PROCESS IN A COVERED CAPILLARY TUBE FOR ACCURATELY SEPARATING THE PROTEIN-BOUND OLIGONUCLEOTIDES” is obtained—and it can also be applied to the analysis of compounds of different kinds and origins, as the example, but not limited to such examples: biological origin sample (blood, plasma, serum, urine, excrement, cerebrospinal fluid, body fluids, semen, saliva, tissue biopsy, inflammatory liquid, nasal excretion, gastric juice, among others), organic molecule, protein, natural peptide, synthetic peptide, nucleic acid, aptamer, carbohydrate, glycoprotein, lipoprotein, organelle, cell, virus, particle, plasma membrane, or other reagents separated by capillary electrophoresis. The compounds cited above can also be pretreated by proper methods, but they are not limited to them, such as lysis, freezing, heating, enrichment, filtering and fractionation.

The compounds cited above can be identified by fluorescence, laser-induced fluorescence, light absorbance, physical-chemical properties, charge and specific mass.

For separating the compounds of different origins and kinds through the process of this patent, the following electrophoretic parameters can be optimized: temperature, voltage, buffer composition, addition of electrophoretic separation mediators to the buffer, buffer pH, capillary dimensions (length, internal diameter, external diameter), chemical composition of the capillary, chemical substance chosen for covering the capillary internally.

The oligonucleotides obtained through the object of this patent—“SINGLE-STAGE ELECTROPHORETIC PROCESS IN A COVERED CAPILLARY TUBE FOR ACCURATELY SEPARATING THE PROTEIN-BOUND OLIGONUCLEOTIDES”—can be used for the:

1—Development of drugs;
2—Identification of new molecules for the development of drugs;
3—Development of methods of in vitro and in vivo diagnoses;
4—Development of medical treatments;
5—Development of aptamers;
6—Development of the following analytical methods: PCR, immuneassays, liquid chromatograph, affinity chromatograph, mass spectrometry or affinity capillary electrophoresis;
7—Identification of protein in proteome analysis;
8—Production of high affinity and high specificity oligonucleotides for identifying, marking, purifying and functionally characterizing the macromolecules, such as proteins, polysaccharides, glycoproteins, hormones, cell receptors and plasma membrane;
10—Production of high affinity and high specificity oligonucleotides for identifying, marking, purifying and functionally characterizing the molecules whose dimensions are compliant with toxins, poisons, metabolites, enzymatic co-factors, colorants, preservatives, oligoelements, heavy metal atoms and inorganic molecules;
11—Production of high affinity and high specificity oligonucleotides for applying in clinical diagnosis laboratory kits, for selecting cells in cultures and tissues—cell sorting method, catheter for identifying the target molecules function, both “in vivo” and “in vitro”, catheter for marking the diagnosis through image or through Petri dishes for cytology, histology and pathology;
12—Production of high affinity and high specificity oligonucleotides in industrial scales for being used as sequestrating agents of synthetic polymers used in the chemical industry and as catalytic agents in industrial-chemical and biochemical processes.

1. “SINGLE-STAGE ELECTROPHORETIC PROCESS IN A COVERED CAPILLARY TUBE FOR ACCURATELY SEPARATING THE PROTEIN-BOUND OLIGONUCLEOTIDES”, or other nonproteic molecules, reduces six of the seven mandatory steps and an optional step of the current State of the Art into one single step with one single electrophoretic migration and it eliminates the electroosmotic effect, being that the oligonucleotides which are obtained can be used for the: Development of drugs; Identification of new molecules to be used in the development of drugs; Development of in vitro and in vivo diagnosis methods; Development of medical treatments; Development of aptamers; Development of the following analytical methods: PCR, immuneassays, liquid chromatograph, affinity chromatograph, mass spectrometry or affinity capillary electrophoresis; Identification of proteins in the analysis of proteomes; Production of high affinity and high specificity oligonucleotides for identifying, marking, purifying and functionally characterizing the macromolecules, such as proteins, polysaccharides, glycoproteins, hormones, cell receptors and plasma membrane; Production of high affinity and high specificity oligonucleotides for identifying, marking, purifying and functionally characterizing the molecules whose dimensions are compliant with toxins, poisons, metabolites, enzymatic co-factors, colorants, preservatives, oligoelements, heavy metal atoms and inorganic molecules; Production of high affinity and high specificity oligonucleotides for applying in clinical diagnosis laboratory kits, for selecting cells in cultures and tissues—cell sorting method, catheter for identifying the target molecules function, both “in vivo” and “in vitro”, catheter for marking the diagnosis through image or through Petri dishes for cytology, histology and pathology; Production of high affinity and high specificity oligonucleotides in industrial scales for being used as sequestrating agents of synthetic polymers used in the chemical industry and as catalytic agents in industrial-chemical and biochemical processes, being also applied in the biological origin sample (blood, plasma, serum, urine, excrement, cerebrospinal fluid, body fluids, semen, saliva, tissue biopsy, inflammatory liquid, nasal excretion, gastric juice, among others), organic molecule, protein, natural peptide, synthetic peptide, nucleic acid, aptamer, carbohydrate, glycoprotein, lipoprotein, organelle, cell, virus, particle, plasma membrane, or other reagents separated by capillary electrophoresis and also by eliminating the fraction collection window, characterized by being carried out in one single electrophoretic migration that takes only about 360 seconds and by collecting the compound formed by the sample protein bound to one or more than one oligonucleotides with a high purity level, such oligonucleotide has high specificity and high affinity with the sample protein, being that the compound shows up in the form of a clear peak (P2) of separation and localization inside the capillary at the electropherogram, being such migration carried out in the capillary tube that is internally covered with neutral hydrophilic substances.

2. “SINGLE-STAGE ELECTROPHORETIC PROCESS IN A COVERED CAPILLARY TUBE FOR ACCURATELY SEPARATING THE PROTEIN-BOUND OLIGONUCLEOTIDES”, according to claim 1, characterized by the fact that the period of time for the collection and attainment of the Peak (P2) takes approximately 30 seconds.

3. “SINGLE-STAGE ELECTROPHORETIC PROCESS IN A COVERED CAPILLARY TUBE FOR ACCURATELY SEPARATING THE PROTEIN-BOUND OLIGONUCLEOTIDES”, according to claim 1, characterized by the fact that the material to be collected is preferably just a fraction contained inside the variable extension segment for collection (S3), located inside the Peak (P2).

4. COVERED CAPILLARY TUBE FOR THE ACCURATE SEPARATION OF THE PROTEIN-BOUND OLIGONUCLEOTIDES”, characterized by the fact that its internal surfaces are covered with neutral hydrophilic molecules that can be octadecylsilyls, polyvynilsiloxanes, cyclodextrins, cellulose, polymetacrilate, amino acids, proteins, peptides, polyamines, other organic acids or any other ones that produce the same phenomenon, for having the same or similar properties.

5. COVERED CAPILLARY TUBE FOR THE ACCURATE SEPARATION OF THE PROTEIN-BOUND”, according to claim 4, characterized by the fact that the covering process of the fused silica capillary internal surfaces takes place in three stages.

6. COVERED CAPILLARY TUBE FOR THE ACCURATE SEPARATION OF THE PROTEIN-BOUND”, according to claim 5, characterized by the fact that the following steps are carried out during the first stage: 1^{st} step—filling up the capillary with HCl in the concentration of 12 M, sealing the capillary ends with flame and incubation at 80° C. for 12 hours; 2^{nd} step—washing the interior of the capillary with deionized water followed by washing it with propanone, followed by washing it with dyeihyl ether, such process being repeated five times by using the PA reagents; 3^{rd} step—drying the capillary with a Nitrogen flow for one hour in room temperature; 4^{th} step—filling up the capillary with an ammonium hydrogen fluoride solution (NH₄HF₂) at 5% in weight per volume, dissolved in methanol and keeping it at rest for an hour in room temperature; 5^{th} step—drying the capillary with a Nitrogen flow for 30 minutes in room temperature; 6^{th} step—sealing the ends of the capillaries with a flame and heating it at temperatures between 300° C. and 400° C. for 3 or 4 hours.

7. COVERED CAPILLARY TUBE FOR THE ACCURATE SEPARATION OF THE PROTEIN-BOUND OLIGONUCLEOTIDES”, according to claim 5, characterized by the fact that the following steps to be taken during the second stage: 1^{st} step—treating the capillary internal surface with a continuous flow of ammonia solution of 0.1-0.2 ml/h (6 mM, pH 10), for 20 hours; 2^{nd} step—washing the interior of the capillary with deionized water followed by its washing with HCl (0.1 M) and, finally, with a new washing with deionized water; 3^{rd} step—drying the capillary with a Nitrogen flow for 30 minutes in room temperature; 4^{th} step—filling up the capillary with a trietoxisilane solution (1.0 M) dissolved in dioxane, sealing the capillary with a flame and incubating it for 90 minutes at 90° C.; 5^{th} step—washing the internal surface of the capillary with a continuous flow of 0.1-0.2 ml/h of hexachloroplatinic acid (THF) for 2 hours, followed by a new washing with a THF solution dissolved in water (1:1) for 2 more hours; 6^{th} step drying the capillary with a Nitrogen flow for 30 minutes at room temperature; 7 step—washing the capillary with toluene for 5 minutes; 8^{th} step—treating the internal surface of the capillary with a continuous flow of 0.1-0.2 ml h of hexachloroplatinic solution 10 ml/h, dissolved in 2-propanol heated at 100° C. for 90 hours; 9^{th} step—about 10 alternated washes of hexachloroplatinic acid and toluene for 1 hour.

8. COVERED CAPILLARY TUBE FOR THE ACCURATE SEPARATION OF THE PROTEIN-BOUND OLIGONUCLEOTIDES”, according to claim 5, characterized by the fact that the following steps are taken during the third stage: 1^{st} step—the choice of the substance that will be used for the covering can be:—octadecylsilyls, polyvynilsiloxanes, cyclodextrins, cellulose, polymetacrilate, amino acids, proteins, peptides, polyamines, other organic acids or any other ones that produce the same phenomenon, for having the same or similar properties; 2^{nd} step—treatment of the capillary internal surface with a continuous flow of 0.1-0.2 ml/h of a solution of the substance chosen in step 1, heated at 100° C. for 90 hours.
